(19) United States
(12) Patent Application Publication
(10) Pub. No.: US 2020/0353312 A1
(43) Pub. Date: Nov. 12, 2020

(54) EXERCISE BAY AND EXERCISE APPARATUS FOR USE WITH SAME

(71) Applicant: Fatty Industries Pty Ltd, Darlinghurst (AU)

(72) Inventor: Cameron Smith, New South Wales (AU)

(21) Appl. No.: 16/765,808

(22) PCT Filed: Nov. 23, 2018
(86) PCT No.: PCT/AU2018/051255

§ 371 Date: May 20, 2020

(30) Foreign Application Priority Data
Nov. 23, 2017 (AU) 2017904730

(51) Int. Cl. A63B 24/00; A63B 21/00; H04N 5/232

(52) U.S. Cl. CPC A63B 24/0062; A63B 21/00069; A63B 21/154; A63B 24/0006; A63B 24/0075; A63B 2225/10; H04N 5/23219; A63B 2024/0093; A63B 2220/05; A63B 2220/806; H04N 5/23299

(57) ABSTRACT

An exercise bay including: an enclosure defining an exercise area; at least one camera directed toward the exercise area for capturing video of a user exercising in the exercise area; and at least one display within the enclosure for displaying content to the user.

### TECHNICAL FIELD

The present invention relates to exercise bays, pods or the like and exercise apparatuses for use with same.

### BACKGROUND

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

It is well known that physical exercise has numerous health benefits. However a significant proportion of the general population avoid physical exercise because of several deterrents.

One common deterrent is the expense associated with the attending gyms classes or hiring a personal trainer. Without professional guidance, it can be difficult for people to prepare and follow an exercise plan. The absence of professional guidance can also lead to injury, as people may perform exercises without proper technique/form. The risk of injury is increased when using weights or other resistance type training.

Another common deterrent is the fear of embarrassment when exercising in public/communal gyms. It is not unusual for people to feel intimidated or embarrassed when exercising amongst others who may be younger or in better physical shape.

In seeking to address these issues, online fitness classes have been created which allow people to exercise in the privacy of their own homes, and often, at a cost that is significantly less than a conventional gym membership. However, these online classes have disadvantages in relation to monitoring and measurement of the user. Wearable sensors/devices have been used track/log user movements and exercise habits, however these devices provide limited guidance to the user on how to correct exercise technique. They are also difficult to configure, and are typically configured for use with a single exercise only (e.g. step counter). Variation between users can also lead to onerous calibration requirements, as well as inaccuracies when logging exercise information.

### SUMMARY

In one broad form, the present invention provides an exercise apparatus including: at least one user operation means; and an adjustable resistance mechanism connected to the at least one user operation means via a cable pulley system, wherein the adjustable resistance mechanism is configured to provide resistance against cable pulling movement of the at least one user operation means.

In one form, the at least one user operation means is movable between a retracted position and an extended position.

In one form, the exercise apparatus includes a plurality of user operation means.

In one form, the at least one user operation means includes handle members configured to be grasped by the hands of a user. In one form, the at least one user operation means includes a sliding bed apparatus. In one form, the sliding bed apparatus includes a bed slidingly mounted on a base frame, wherein the bed is connected to the adjustable resistance mechanism via the cable pulley system.

In one form, the sliding bed apparatus is movable between a deployed position, wherein the sliding bed apparatus is accessible for use by a user, and a stowed position, wherein the sliding bed apparatus is not accessible for use by a user. In one form, a boxing apparatus is mounted to the underside of the sliding bed apparatus, such that, when the sliding bed apparatus is in the stowed position, the boxing apparatus is accessible for use.

In one form, the exercise apparatus includes a control unit. In one form, the control unit is configured to receive input in relation to a desired resistance or resistance profile, and control the level of resistance provided by the adjustable resistance mechanism accordingly.

In one form, the adjustable resistance mechanism is pneumatically powered. In one form, the adjustable resistance mechanism includes at least one pneumatic cylinder.

In one form, the apparatus is configured such that cable pulling movement of the at least one user engagement means causes linear movement in a first direction of at least one slider connected to the adjustable resistance mechanism, wherein the at least one slider is connected to a first end of one or more pneumatic cylinder(s), and movement of the slider in the first direction compresses the one or more pneumatic cylinder(s).

In one form, the at least one slider is pivotally connected to the one or more pneumatic cylinder(s) such that, with movement in the first direction, the angle between the first direction and the expansion direction of the one or more pneumatic cylinder(s) increases such that the resistance provided against movement of the slider in the first direction by expansion of the cylinder decreases, and compensates for increasing resistance occurring due to compression of gas in the one or more pneumatic cylinders(s) such that a substantially constant resistance is provided by the resistance system during the cable pulling movement.

In one form, the control unit is configured to control the level or resistance by controlling amount of gas in the at least one pneumatic cylinder.

In one form, the control unit is configured to receive input in relation to a desired exercise to be performed, and to deploy, optimise and/or initialise the user operation means that are appropriate for performing that exercise.

In one form, the bed includes handle means positioned thereon so as to permit a user to perform a deadlift type action, and/or a back rest so as to permit a user to perform a leg press type action, and/or shoulder rests so as to allow a user to perform a squatting action.

In one form, the at least one user operation means includes a seated rowing apparatus.

In one form, the exercise apparatus includes at least one displacement measurement device to measure information related to exercise stroke. In one form, the control unit is configured to process information from the at least one displacement measurement device and dynamically adjust resistance provided by the adjustable resistance mechanism.

In a further broad form, the present invention provides, an exercise bay including: an enclosure defining an exercise area; at least one camera directed toward the exercise area for capturing video of a user exercising in the exercise area; and at least one display within the enclosure for displaying at content to the user.

In one form, the at least one display is configured to display a real time video feed of the user captured from the at least one camera. In one form, the at least one display is configured to display a real time video feed of the user simultaneous with a second video feed. In one form, the content of the second video feed is selected from a library of exercises or exercise routines.

In one form, multiple cameras are positioned to capture video of the user from multiple angles.

In one form, the modular exercise bay includes a control system. In one form, the control system is configured to receive user input in relation to an exercise or exercise routine to be performed by the user.

In one form, the control system is configured to control the content displayed on the at least one display in accordance with an exercise to be performed by the user.

In one form, the control system is configured to selectively operate, and/or adjust the orientation of, the at least one display in accordance with an exercise to be performed by the user such that visibility of the video feed(s) is optimised for the user when performing the exercise.

In one form, the control system is configured to selectively operate, and/or adjust the orientation of, the at least one camera in accordance with an exercise to be performed by the user such that the one or more video angles captured for display to the user are optimised for self assessment by the user of their exercise form.

In one form, the modular exercise bay includes at least one exercise apparatus therein. In one from, the control system is configured to control the configuration of one or more of the at least one exercise apparatus.

In one form, the control system is configured to receive input in relation to a user's characteristics or identity, and based on that input, optimise any one of the at least one exercise apparatus for the user.

In one form, the enclosure has opaque or translucent walls, such that a user exercising within the enclosure is not visible or identifiable from outside the enclosure.

In one form, the control system is configured to process image data of a user captured from the at least one camera to determine an optimised configuration of the at least one exercise apparatus for the user, and to configure the at least one exercise apparatus accordingly.

In one form, the control system is configured to receive input in relation to exercise stroke, and to configure one or more of the displays to display information about exercise stroke to the user. In one from, input in relation to exercise stroke information is received from a wearable sensor, a displacement measurement device, or by processing of camera image data.

In one form, the control system is configured to compare image data from the at least one camera of a user performing a particular exercise against image data from a second video feed of instructional video for that exercise, and, based on the comparison alert the user in real time when they deviate from the exercise technique as shown in the instructional video.

In one form, the modular exercise bay includes an exercise apparatus as described in any one of the forms described herein.

In a further broad form, the present invention provides an exercise bay including: an enclosure defining an exercise area for a user; at least one exercise apparatus within the enclosure; and at least one display within the enclosure for displaying content to the user.

In a further broad form, the present invention provides an exercise bay including: an enclosure defining an exercise area; at least one sensor directed toward the exercise area configured to collect information about a user exercising in the exercise area; and a feedback device configured to provide feedback to a user about their exercising based on information received form the at least one sensor.

In one form, the feedback device is configured to provide audio and/or visual feedback to a user about their exercise form.

In one form, the feedback device is configured alert the user when they deviate from proper exercise form.

In one form, the feedback device is a display screen, augmented reality or virtual reality headset, and/or a speaker.

In one form, the at least one sensor includes an optical sensor, image sensor, electrical sensor, audio sensor, camera, and/or heart rate monitor.

### BRIEF DESCRIPTION OF THE DRAWINGS

An example of the present invention will now be described with reference to the accompanying drawings, in which:

FIG. 1 is a perspective view of one example of the an exercise bay according to one aspect of the invention;

FIG. 2 is a perspective cut away view of the exercise bay of FIG. 1;

FIG. 3 is a front perspective view of two exercise bays according to one example positioned side by side, showing a sliding bed apparatus in the deployed and stowed position respectively;

FIG. 4 is front view of a two exercise bays according to one example positioned side by side, showing a sliding bed apparatus in the deployed and stowed position respectively;

FIG. 5 is top view of two exercise bays according to one example positioned side by side, showing a sliding bed apparatus in the deployed and stowed position respectively;

FIG. 6 is a top view of one example of an exercise apparatus that may be used with the exercise bays as described herein;

FIG. 7 is a rear view of one example of an exercise apparatus that may be used with the exercise bays as described herein;

FIG. 8 is a front perspective view of one example of an exercise apparatus that may be used with the exercise bays as described herein;

FIG. 9 is a side view of one example of an exercise apparatus that may be used with the exercise bays as described herein;

FIG. 10 is a perspective view of one example of a sliding bed apparatus;

FIGS. 11A and 11B show pneumatic cylinder arrangement of one example of the exercise apparatus and movement of same during exercise stroke;

FIG. 12 shows a cutaway view of one example of an exercise apparatus illustrating cable pulley system;

FIG. 13A shows a front perspective view of an example of sliding bed apparatus for use with the exercise apparatus, and FIGS. 13B and 13C show an underside and top perspective view of the bed/sled according to one example of the exercise apparatus;

FIGS. 14A, B and C show an squatting action implementation of one example of the sliding bed apparatus, with FIG. 14A showing squat position; FIG. 14B showing the standing position with bed locked in position, and FIG. 14C showing the standing position with bed unlocked;

FIG. 14D shows an example of the sliding bed when disengaged from the adjustable resistance mechanism and connected to a spring resistance mechanism;

FIG. 14E shows an example of the Deadlift action implementation of on example of sliding bed apparatus;

FIG. 15 is a system map showing a typical control system layout for the modular exercise bay and exercise apparatus;

FIG. 16 is a perspective view of one example of an exercise bay according to the invention;

FIG. 17 is a perspective view of the exercise bay of FIG. 16, having sliding bed apparatus in the stowed position;

FIG. 18 is a front view of exercise apparatus within the exercise bay of FIG. 16;

FIG. 19 shows an example of a cable pull type exercise being performed by a user in the exercise bay of FIG. 16;

FIG. 20 shows a perspective view of exercise apparatus within the exercise bay;

FIG. 21 shows a side view of a user performing a squat type exercise in the exercise bay of FIG. 16;

FIG. 22 shows a side view of one example of a bed portion of a sliding bed apparatus that may be used in exercise bays as described herein;

FIG. 23 shows a side view of foot rest of one example of a sliding bed apparatus according to one example;

FIG. 24 shows a side view of a double pivoting pad so a sliding bed apparatus according to one example;

FIG. 25 shows a side view of one example of a Pilates type exercise being performed in the exercise bay of FIG. 16;

FIG. 26 shows perspective view of slide-in accessory storage compartments in exercise bay of FIG. 16; and

FIG. 27 shows a front view of two exercise bays of the type shown in FIG. 16 positioned adjacent one another to form a larger exercise bay.

### DETAILED DESCRIPTION

Embodiments of the present invention provide an exercise bay and/or exercise apparatus that may be used with same.

The exercise bay includes an enclosure that provides an exercise area for a user to perform exercise. The exercise bay includes at least one camera directed toward the exercise area to capture video of the user performing exercise. The exercise bay also includes at least one display within the enclosure. Typically, the exercise bay is a substantially self-contained pod, module or the like. It will be appreciated that the display may take a variety of forms, and may, for example be a screen (e.g. computer or TV screen) or an augmented reality/virtual headset.

The display(s) of the exercise bay may be configured to display a range of content to the user. In one form, the display(s) is/are configured to display a real time video feed of the user. In another form, the display(s) is/are configured to display a real time video feed of the user simultaneous with a second video feed. In one example, the content of the second video feed may be selected by the user (or another person, such as the user's trainer) and may relate to an exercise or exercise routine the user would like to perform. The content of the second video feed may, for example, be selected from a pre-recorded video library of exercises or exercise routines, may be a live video feed of an instructor, or may be a computer generated video feed of a computer generated avatar performing the relevant exercise.

Such simultaneous display of video feeds allows a user to self assessed themselves when performing a particular exercise/exercise routine by comparing a real time video feed of themselves against a video feed of the same exercise/exercise routine as performed by a professional instructor (or computer generated instructor). Generally, to facilitate the comparison, the display(s) in the exercise bay is/are configured such that the real time video feed and second video feed are displayed side by side, either on separate displays, or stitched together on a single display.

In such forms, it will be appreciated that the exercise bay provides the benefits a personal trainer, gym instructor or the like, on demand. By allowing a user to compare themselves against a pre-recorded or live video feed of a professional instructor (or a computer generated video feed of a computer generated avatar) performing the same exercise, the user is able to ensure they are performing the movements correctly, and the chances of injury are reduced. Typically, the exercise bay includes multiple cameras configured to capture different angles of the user (e.g. from the front and side).

It will be appreciated that the exercise bay may also include one or more exercise apparatus therein. Exercise apparatuses may include, for example, functional trainers (i.e. cable pull machines), Pilates reformer beds or other sliding bed equipment, weight benches, rowing machines, pneumatic resistance equipment etc. The exercise bay may also be left empty or equipment therein rearranged such that there is floor space to perform exercise routines that do not require equipment, such as, for example, yoga or aerobics.

A control system is typically included that is configured to control aspects of the exercise bay automatically and/or based on user input. For example, the control system may be configured to control the content displayed on the display(s). The control system may also be configure to control the configuration of one or more of the at least one exercise apparatus. Typically, the control system is configured to adjust the exercise bay in accordance with an exercise to be performed by a user. As previously described, the exercise to be performed may, for example, be selected by the user or another person, such as the user's trainer.

It will be appreciated that the control system may take a variety of forms but is typically an electronic processing/control system with a plurality of interconnected components that may include, for example, processors, computer systems, microcontrollers, input/output devices, network communication capability, memory components, mechanical actuators etc. Generally, a user interface permits user input to the control system. The user interface may be, for example, a touch screen or keypad located within or outside the enclosure of the exercise bay. In some examples, the control system may receive input from, or otherwise communicate with a user's smart phone or wearable device (e.g. via wireless communication). A user may also input commands via voice.

In one typical example of use of the exercise bay, a user would enter the exercise bay and input (e.g. via voice or keypad) an exercise they would like to perform along with other parameters, such as, for example, the desired intensity or resistance level for the exercise. In accordance with the user input, the control system would then configure the display to show the appropriate video feed of the exercise, and automatically deploy and configure the appropriate exercise apparatus for performing that exercise. The user would then perform the exercise whilst at the same time self assessing their real time video feed (which may include views from multiple angles) against a video of a professional performing that exercise.

The control system may also be configured to allow storage and retrieval a user profile/information. For example, a user profile may store details of previous training sessions to track progression, or may store details about preferred equipment settings. Typically, the exercise bay allows communication via a communication network to a remote database where user profile information is stored. For example, the control system may support WIFI or other communication interfaces that permit connectivity to the internet (or other WAN) to allow transmission/retrieval of the user profile to/from remote storage (e.g. cloud based database). A user may for example ‘log in’ on entering the exercise bay, and, once authenticated, the control system may retrieve their user profile. It will be appreciated that the user profile may also be stored locally in memory connected to, or that is part of, the control system.

It will be appreciated that the control system may be configured to control other aspects of the exercise bay. For example, the control system may be configured to select one or more of the displays and/or adjust the orientation of a display in accordance with an exercise being performed by the user. This automatic orientation and/or screen selection ensures a user is able to clearly view the video feeds without compromising their form when performing a particular exercise. The control system may also selectively operate particular cameras and/or adjust camera orientation in accordance with an exercise being performed by the user, so as to provide the optimal camera angles for self assessment of that particular exercise.

To provide an element of privacy for the user, the enclosure of the exercise bay may have opaque or translucent walls such that a user exercising within the enclosure is not visible or identifiable from outside the enclosure. This addresses fear or embarrassment that may be experienced by some people when exercising in front of others. As well as providing privacy, opaque or translucent walls allow a user to more clearly assess their exercise form in their video feed, as there is no confusion as to their body outline or distraction due to background items. In some examples, the control system may include image analysis software to automatically detect deviation of a user from good/proper exercise form. In such examples, having opaque or translucent walls would typically allow the software to work more effectively. The control system may, for example, automatically alert the user as to any deviation from proper from by displaying a message or graphic on the display or by playing a sound.

It will also be appreciated that the enclosure may not always be provided by rigid walls, and alternatively, for example, may be provided by a hanging curtain around the exercise area. It will also be appreciated that the enclosure may not be a structure that provides complete sealing of the exercise area, for example, the enclosure may have windows or openings to allow adequate ventilation, and in some examples, may have an entirely or partially open ceiling. Typically, the aim of the enclosure is to mark out an exercise area for the user and at the same time provide an element of privacy. The exercise bays as described here may also be configured as modules that can be connected together. In some examples portions of common walls of neighbouring bays may be removed so as to provide a larger combined bay, where multiple participants may exercise together privately.

An aspect of the present invention also relates to an exercise apparatus compatible for use with the exercise bays as described herein. Generally, the exercise apparatus includes at least one user operation means and an adjustable resistance mechanism connected to the at least one user operation means via a cable pulley system. The adjustable resistance mechanism is configured to provide resistance against cable pulling movement of the at least one user operation means. It will be appreciated that cable pulling movement refers to any movement of the user operation means which pulls against resistance provided by the resistance mechanism and may, for example, be provided by a user performing a pushing action (e.g. chest press).

Generally, the cable pulley system is mounted to a frame or other support structure. To perform resistance exercise, the user moves the at least one user operation means between a retracted position and an extended position. It would be appreciated that the cable pulley connection to the resistance mechanism provides that resistance is applied against movement of the user operation means from the retracted position to the extended position.

Typically, the exercise apparatus includes a plurality of different user operation means to allow for different exercise modalities. For example, user operation means may include handle members configured to be grasped by the hands of a user, that allow exercises to be performed similar to those performed on a conventional functional trainer or cable pull machine. Alternatively or additionally, the user operation means may include a sliding bed apparatus like a Pilates reformer bed or the like. A sliding bed apparatus would typically includes a bed slidingly mounted on a base frame, with the bed being connected to the adjustable resistance mechanism via the cable pulley system. Typically, movement of the bed along the base frame in one direction, i.e. from a retracted to an extended position, is against the resistance provided by the resistance mechanism. It will be appreciated that the sliding bed apparatus may allow a user to perform a range of different resistance type exercises, such as, for example leg press, squat and dead lift type exercises. It will also be appreciated that the sliding bed may also be configured as or replaced with a sliding carriage, sled, seat or the like (e.g. for rowing type exercises).

The exercise apparatus may also be configurable such that certain components are movable between deployed positions and stowed positions. For example the sliding bed apparatus may be movable between a deployed position, wherein the sliding bed apparatus is accessible for use, and a stowed position, wherein the sliding bed apparatus is not accessible for use. In one example, the sliding bed apparatus is stowed by folding it into the frame of the larger exercise apparatus. In some forms, a boxing apparatus may be mounted to the underside of the sliding bed apparatus so that, when the sliding bed apparatus is folded into in the stowed position, the boxing apparatus is accessible for use. In an alternative example, rather than being folded away, the sliding bed apparatus may be lowered into the floor of the exercise bay.

The exercise apparatus may include a control unit. It will be appreciated that the control unit typically includes an electronic control/processing device, such as, for example, a micro controller or micro-computer. The control unit is typically configured control the level of resistance provided by the adjustable resistance mechanism. For example, a user may input the desired resistance level into the control unit, and the control unit would control the resistance accordingly. Typically the adjustable resistance mechanism is pneumatically powered, and includes at least one pneumatic cylinder. In some examples, the control unit is configured to control the level or resistance by controlling amount of gas in the pneumatic cylinder(s). It will be appreciated that, when used in conjunction with the exercise bay, the control unit may be integrated with or part of the control system of the exercise bay.

Generally, the resistance mechanism is configured to provide a constant resistance to cable pulling movement of the user operation means so as to mimic the resistance provided by conventional weights. This may be achieved in a variety of ways. In one example the apparatus is configured such that cable pulling movement of the at least one user operation means causes linear movement in a first direction of at least one slider connected to the adjustable resistance system. The at least one slider is connected to a first end of one or more pneumatic cylinder(s), and movement of the slider in the first direction compresses the one or more pneumatic cylinder(s). Furthermore, the at least one slider is pivotally connected to the one or more pneumatic cylinder(s) such that, with movement of the slider in the first direction, the angle between the first direction and the expansion direction of the one or more pneumatic cylinder(s) increases such that the resistance provided against movement of the slider in the first direction by expansion of the cylinder decreases, and compensates for increasing resistance occurring due to compression of gas in the one or more pneumatic cylinders(s). In this way, a substantially constant resistance is provided by the resistance system during the cable pulling movement of the user operation means.

In other forms, or when configured in other modes, the resistance mechanism may operate with varying or non-constant resistance during an exercise stroke or exercise set. For example, the control unit may be configured to provide a varying resistance profile during different parts of the exercise stroke, or may set the resistance to increase or decrease with each repetition (“rep”). It will be appreciated that, in addition to controlling the adjustable resistance mechanism, the control unit of the exercise apparatus may also be configured to deploy or configure any one of the at least one user operation means. For example, the height of any handles, or the starting position of the sliding bed.

Whilst the exercise apparatus as described is particularly suited for use with the exercise bays as described herein, the exercise apparatus may also be implemented on its own, in other circumstances.

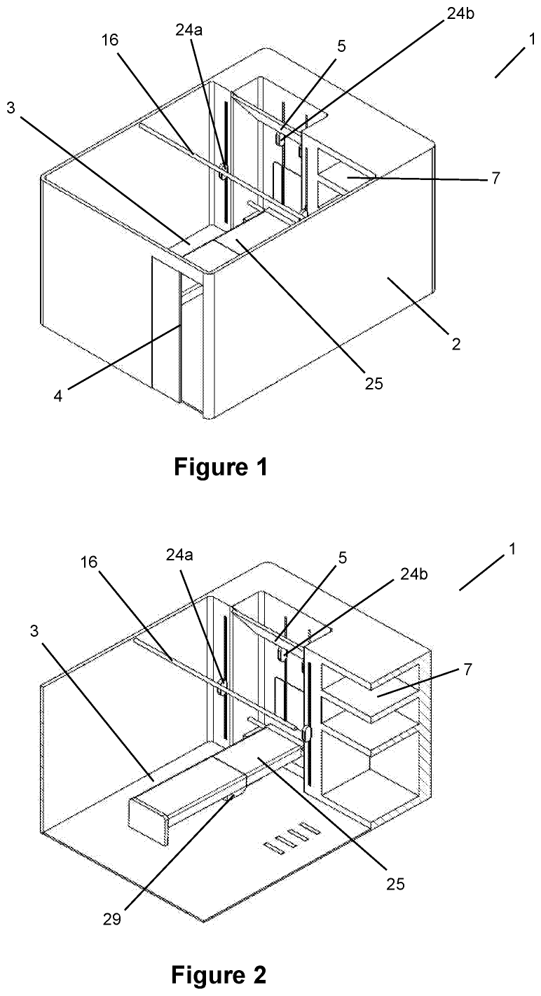

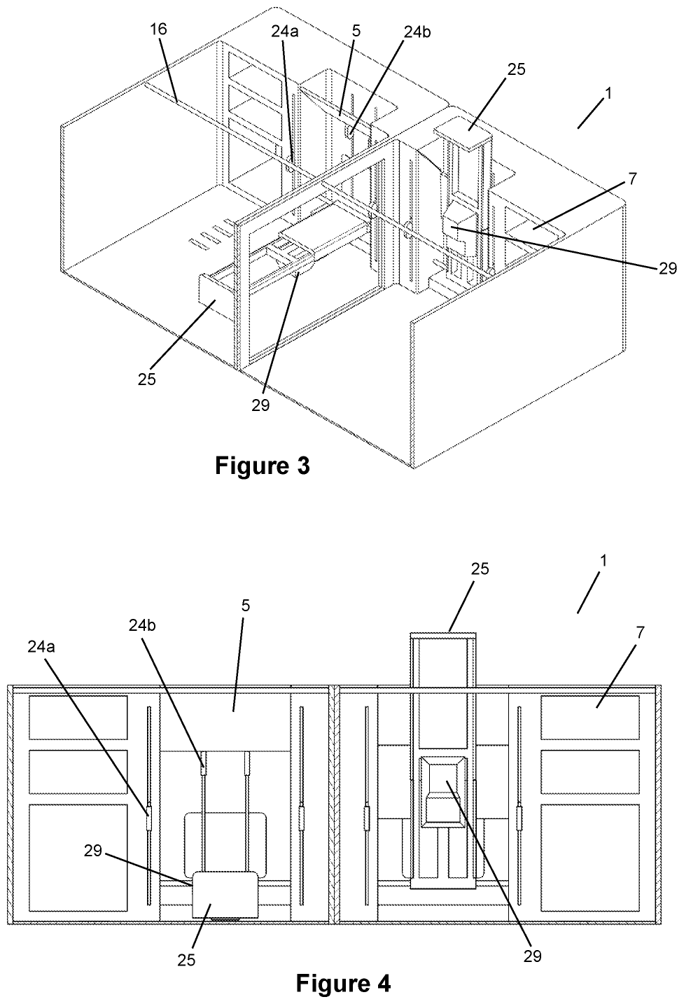

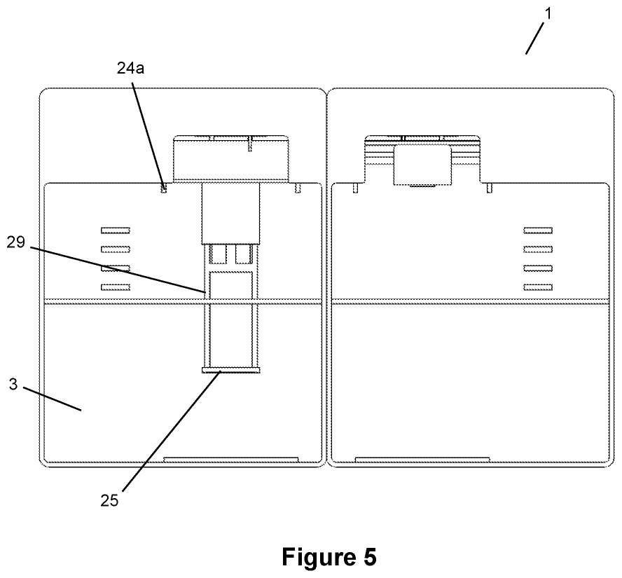

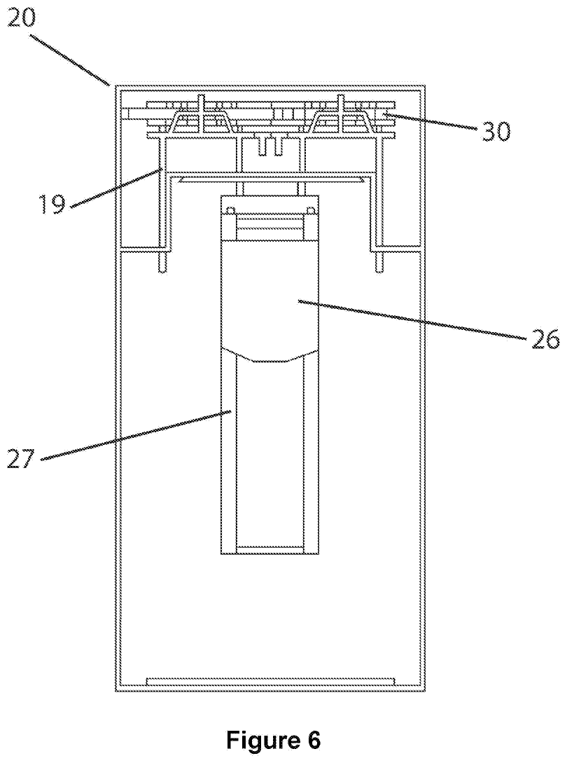

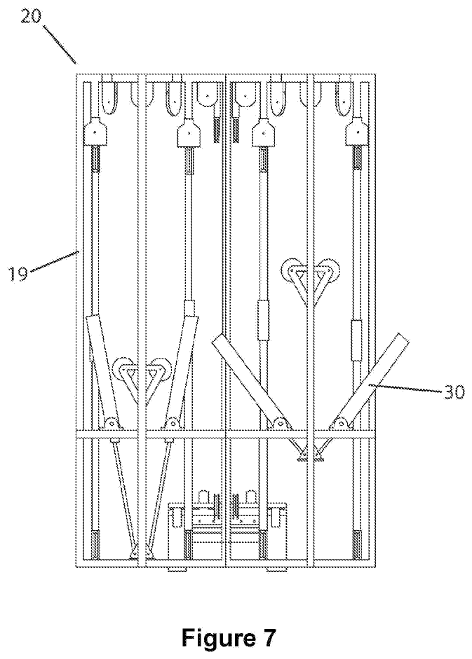

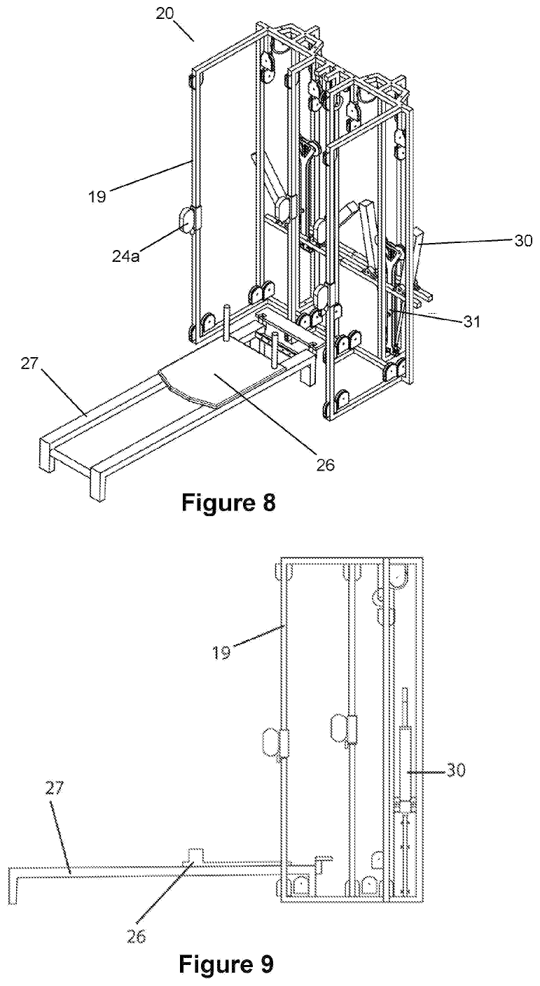

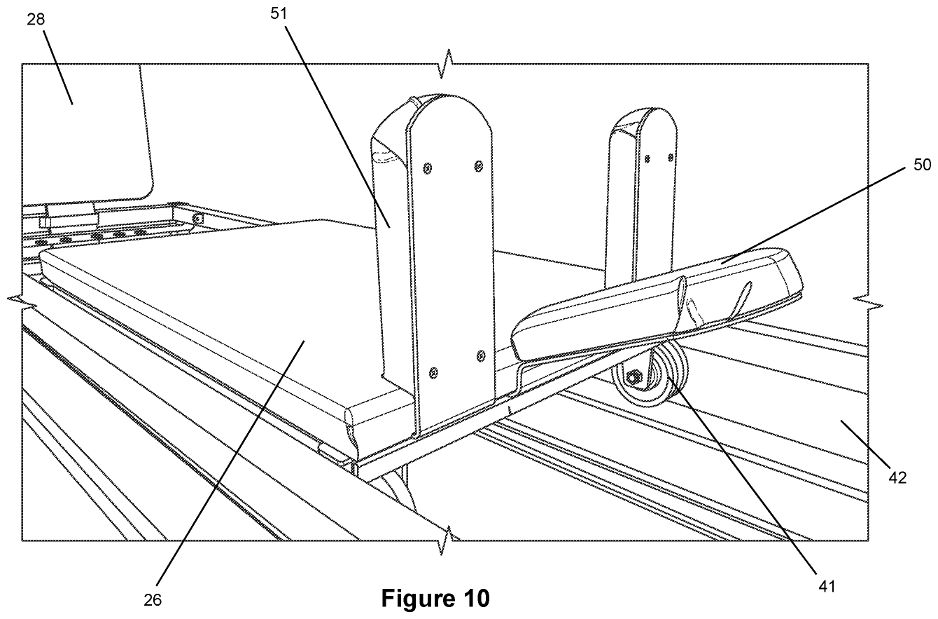

One particular embodiment of an exercise bay according to the invention is shown in FIGS. 1 to 5. FIG. 1 shows an exercise bay (1) that includes an enclosure (2) defining an exercise area so as to provide a pod or module. The enclosure (2) defines a rectangular exercise area, with four side walls (3) and a door (4) that allows entry/exit to the exercise area (3). The rectangular/cube shaped enclosure allows optimal use of floor space when deploying multiple exercise bays (1) such as, for example, at a gym facility or the like. FIGS. 3 to 4 illustrate how multiple exercises bays (1) may be arranged side by side in modular format, and how common walls may be removed to provide a larger enclosure for multiple participants. It will be appreciated that, in other embodiments, the bays (1) may define circular or other shaped exercise areas.

One or more cameras (not shown) are provided in the enclosure (2) to capture video of a user exercising in the exercise area (3). Typically, multiple cameras are included to capture different angles of the user. In some forms, cameras may be included to capture left, right, front, rear and top views of the user.

A display (5) is located in the enclosure (2) to display content to the user. A range of content may be displayed to the user such as pre-recorded instructional videos, live video feeds, or conventional television programming. In one mode, the display (5) may be configured to receive and display live video of user captured from the camera(s) in the enclosure (2). Simultaneously, the display (5) may be configured to display a second video feed that relates to a particular exercise or exercise routine the user wishes to perform. Typically, the second video feed is of a professional trainer or the like performing the particular exercise or exercise routine. Simultaneous display of the live user video feed and the professional video feed (which may be pre-recorded or live) allows the user to self-assess their exercise from/technique without a trainer/instructor being physically present. Typically, the bay (1) will include camera(s) in all necessary positions to provide clear and unobstructed video of the user in any of the intended exercise positions such that they can receive unobstructed visual feedback from a range of angles allowing them to accurately self-assess their exercise form.

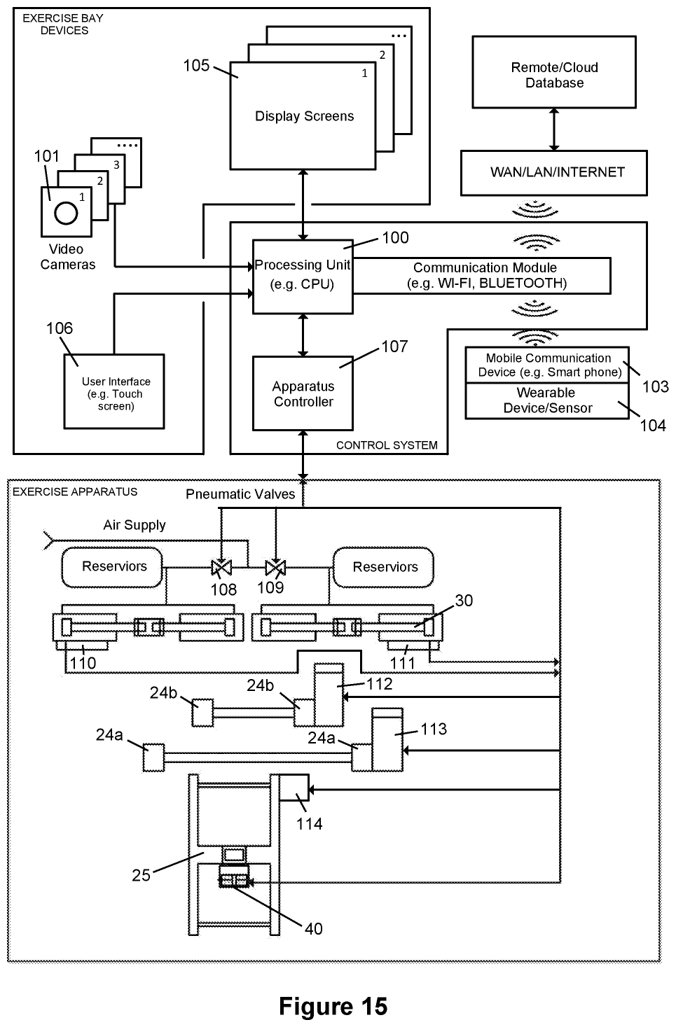

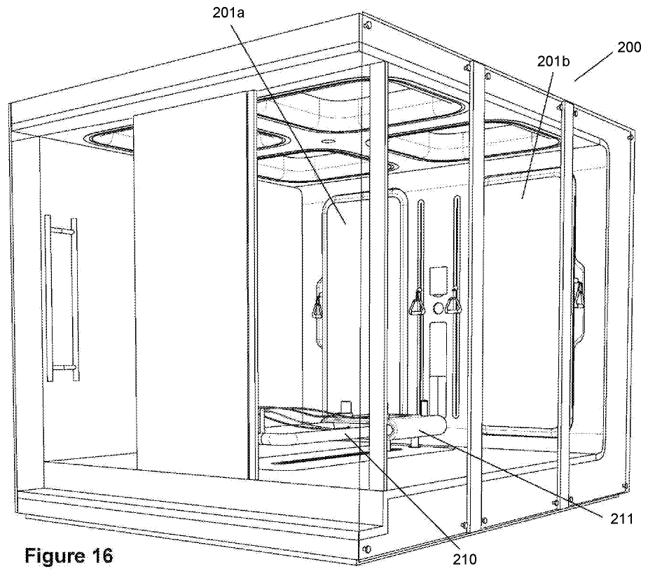

Generally, the second video feed is selected from pre-recorded video library of exercise or exercise routines but may also be a live video feed or a computer generated video feed. A user interface connected to the control system (e.g. see FIG. 15) allows the user to select an exercise to be performed. The user may be shown a list of available exercises on the display (5) or on the user interface itself. Once selected, the control system would configure the display to show the exercise to be performed, alongside the live video feed of the user. Whilst performing the exercise, the user is able to compare their technique/form with the correct form as exemplified by the trainer in the adjacent video feed. It would be appreciated that a pre-recorded video library of exercises/exercise routines may be stored in local memory that is part of or connected to the control system, or may be retrieved from a remote location, such as, for example, a web/cloud based server/database. It will also be appreciated that a live video feed of a personal trainer/instructor may be streamed into the exercise bay. A computer generated instructor/avatar may also be displayed.

In some forms, the control system may also include image analysis software such that it is able to automatically analyse the live video feed of the user and detect deviations from the correct exercise form as shown in the second video feed of the professional instructor. When a deviation is detected, the system may be configured to alert the user accordingly. For example, a message may be shown on one of the displays (5) or a sound may be played through a speaker. It will also be appreciated that in some forms, rather than a user comparing their form against video of a real person, the exercise bay may include functionality whereby the user compares themselves against a computer generated person (e.g. a computer generated avatar). In some examples, the user may undergo a body scan with the system using the body scan information to generate an accurate avatar of the user. The user can then follow an avatar of themselves performing a particular exercise. The exercise bay may include body scan functionality.

In some forms, a range of image sensors may be included to capture image information for processing, for example, still cameras may also be included. The video camera(s) may also be configured to capture still images.

One or more exercise apparatuses may be integrated in the exercise bay (1). On selection of a desired exercise, the control system is also typically configured to deploy and/or initialise the appropriate exercise apparatuses within the exercise bay. The control system may also be configured to automatically select and/or orient particular cameras in accordance with an exercise to be performed such that the most appropriate video angles of the user are captured for self assessment of their exercise technique. Similarly the control system may be configured to automatically select and/or orient one or more of the displays in accordance with an exercise to be performed such that the user is able to view the video feeds with minimal impact to their exercise form (i.e. visibility of video feeds is optimised in accordance with the exercise being performed). An exercise to be performed may be selected by the user, by another person (e.g. user's trainer), or may be proposed automatically using information stored in a user's profile/record.

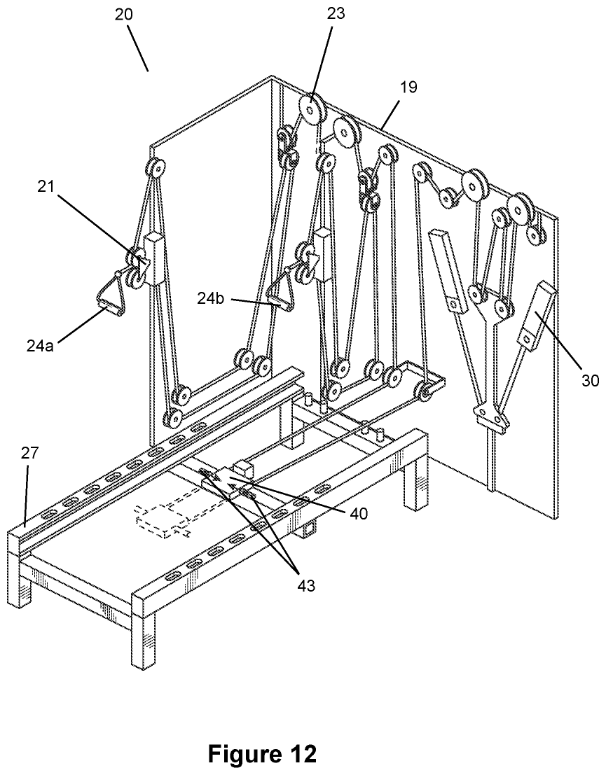

A variety of different types of exercise apparatuses may be incorporated into the exercise bays as described herein. In the figures shown, an exercise apparatus (20) is integrated that allows multiple exercises to be performed. The exercise apparatus (20) includes a plurality of user operation means (21) and an adjustable resistance mechanism (22) connected to the operation means (21) via a cable pulley system (23). The adjustable resistance mechanism (22) provides resistance against cable pulling movement of the at least one user operation means. As best shown in FIG. 12 the cable pulley system is mounted to a frame (19) and is connected to handles (24a, 24b) and a sliding bed apparatus (25). The user can operate the either the handles or the sliding bed to perform different exercises against the resistance provided by the resistance mechanism. In this example, the adjustable resistance mechanism is a pneumatically powered and includes multiple pneumatic cylinders (30).

For example, a user can extend and retract handles (24a, 24b) to perform exercises that would be conventionally performed on a functional trainer or cable pull machine. Two sets of handles are provided, a first narrow set (24b), and a second wider placed set (24a) to allow variations in the exercises performed (e.g. wide or narrow grip chest press). The user would typically adjust the height of the handles via the user interface/control system. In one example, the handles are mounted to a linear belt drive connected to the control system. A user may, for example, input the desired handle height via the user interface, or alternatively, sensors may be included to detect the user's height and the control system would adjust the handles automatically. In one example, data from the one or more cameras may be processed by the control system to determine the user's height.

In the example shown in the figures, the wide and narrow handle sets (24a, 24b) are provided on four vertical columns in the frame (19), i.e. one handle per column moving vertically thereon. However, it will be appreciated that, in other forms wide and narrow handle placement may be provided with two handles only, using a two-axis movement system, wherein the handles may be configured to move horizontally and vertically.

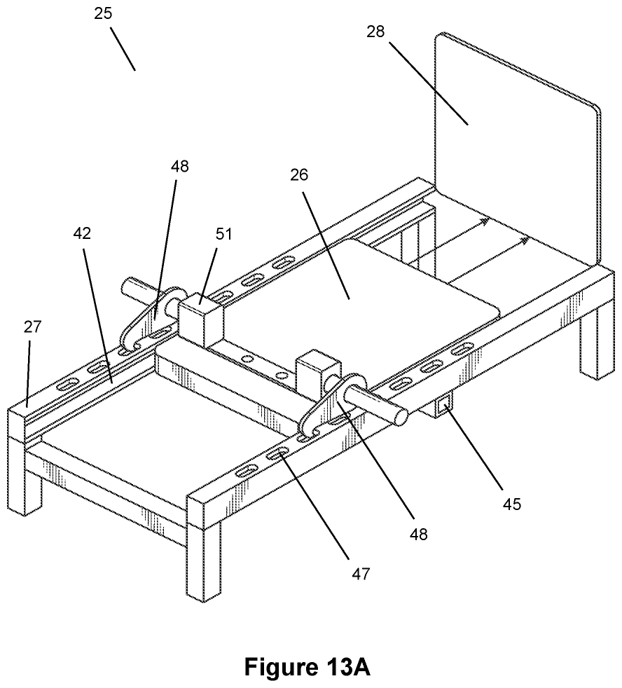

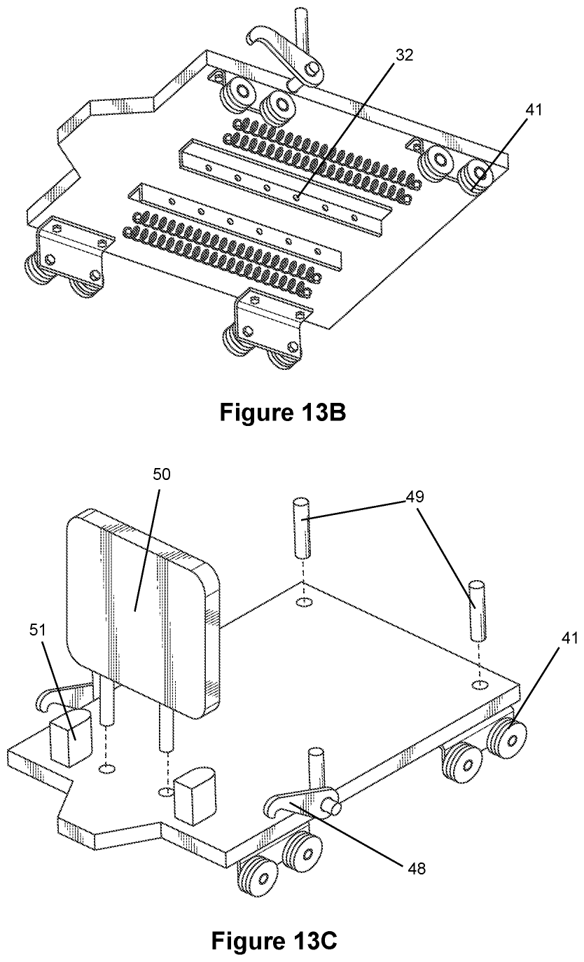

The sliding bed apparatus (25) allows a user to perform Pilates, leg press, squat and deadlift type exercises depending on its mode of operation. It includes a base frame (27) with bed/sled (26) slidably mounted thereon. Typically the bed/sled includes rollers (41) configured to be mounted in corresponding rails (42) in the frame (e.g. see FIG. 13). To facilitate leg press, deadlift and squatting type exercises a foot plate (28) is included at the end of the sliding bed apparatus (25). For deadlift exercises, removable handles (49) may be placed in the bed/sled (26), and for leg press exercises a removable back rest (50) included. Shoulder rests (51) are typically included to facilitate squatting exercises.

FIG. 12 shows cable pulley system integration with the frame (19), sliding bed apparatus (25) and handles (24a, 24b). As shown, a connector (40) is provided to connect the bed/sled (26) of the sliding bed apparatus to the cable pulley system (23). The connector (40) includes a linear actuator (typically a solenoid actuator) having rods (43) that extend and retract to engage/disengage openings (32) in rails in the underside of the bed (26).

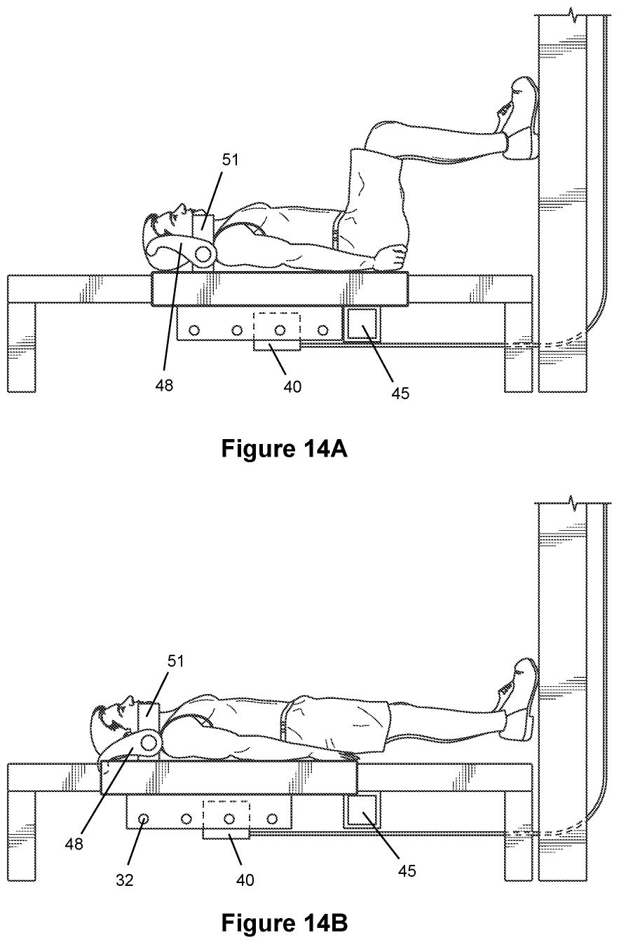

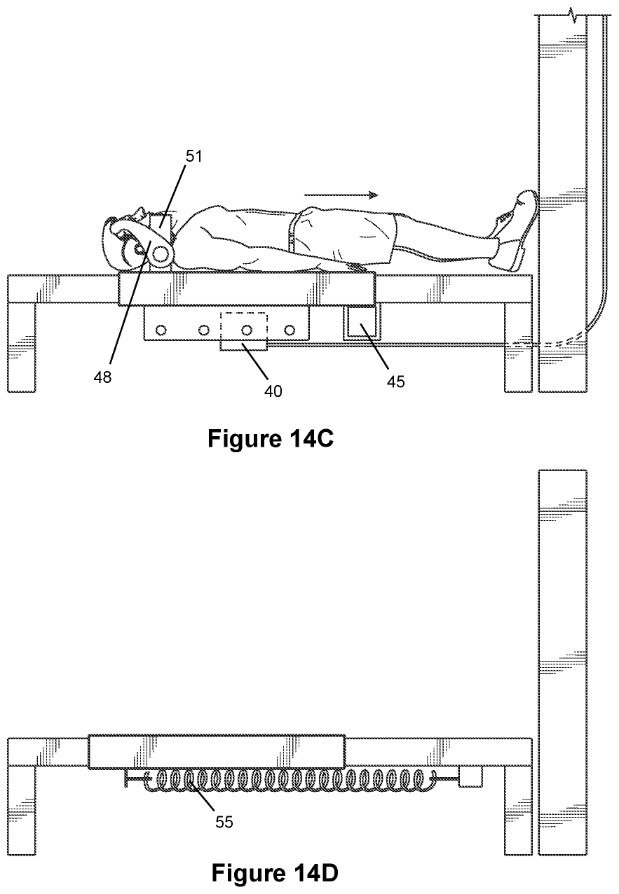

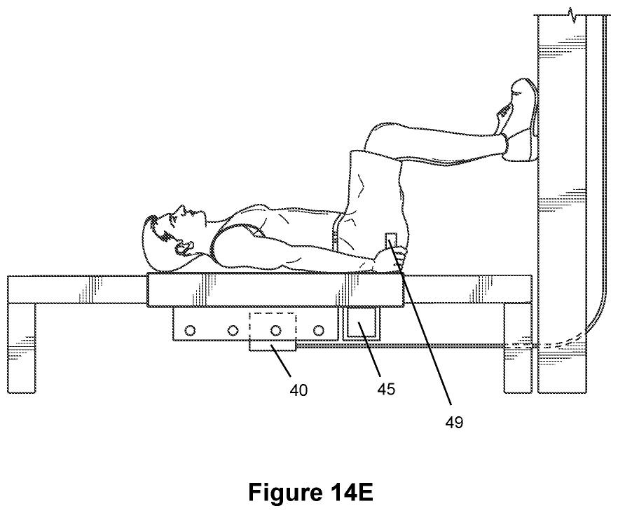

Typically, the connector (40) is controlled by the control system, although, it will be appreciated that the sled/bed (26) may also be configured to be disconnect from cable pulley system manually. It will be appreciated that the cable pulley system, and therefore adjustable resistance mechanism, may be engaged when the user wants to perform resistance exercises and may be disengaged to perform non-resistance type movements. In one form, the sliding bed apparatus may be configured for Pilates type exercises by disengaging the cable pulley system and engaging spring resistance (55) as shown, for example, in FIG. 14D. FIG. 14E shows a bed modified for deadlift type exercises that includes handles (49) thereon. When connected to the cable pulley system, the user is thus able to perform a deadlift type exercise. As previously described the user may also perform a leg press type exercise by inserting the back rest (50).

As the adjustable resistance mechanism is pneumatically powered and is controllable by the control system, the resistance can be engaged/disengaged, or set to zero, at any point in the exercise ‘stroke’. This allows operation similar to a conventional squat rack. FIGS. 14A to C show the bed (26) when configured for squatting, including shoulder rests (51). When performing a squat, a user may reduce the resistance to zero and move the bed into the fully extended position where their legs are fully extended (FIG. 14B). The bed can then be locked into position by engaging lock/hook arms (48) of the bed into rack holes (47) in the frame (27). Once locked, the resistance can be applied, and when ready to squat (FIGS. 14A to 14C), the user can disengage the lock/hook arms (48). Similarly a user can ‘rack’ the sled/bed/carriage at any time during the exercise stroke by engaging the lock/hook arms (48) with the frame (27). A stopper (45) prevents over retraction of the bed towards frame (19).

It will also be appreciated that the sliding bed apparatus may be configured as a rowing machine or the like, wherein the sliding bed/sled is a sliding seat, carriage or the like, and a rowing handle attachment is connected to the pulley system. It will be appreciated the rowing handle attachment may also be configured to be connected to convention cardio fan device, with resistance provided therefrom.

As shown in FIGS. 3 and 4, the sliding bed apparatus (25) may be moved between stowed and deployed configurations. In the stowed configuration, a boxing apparatus (29), mounted to the underside of the sliding bed apparatus (25), is accessible for use.

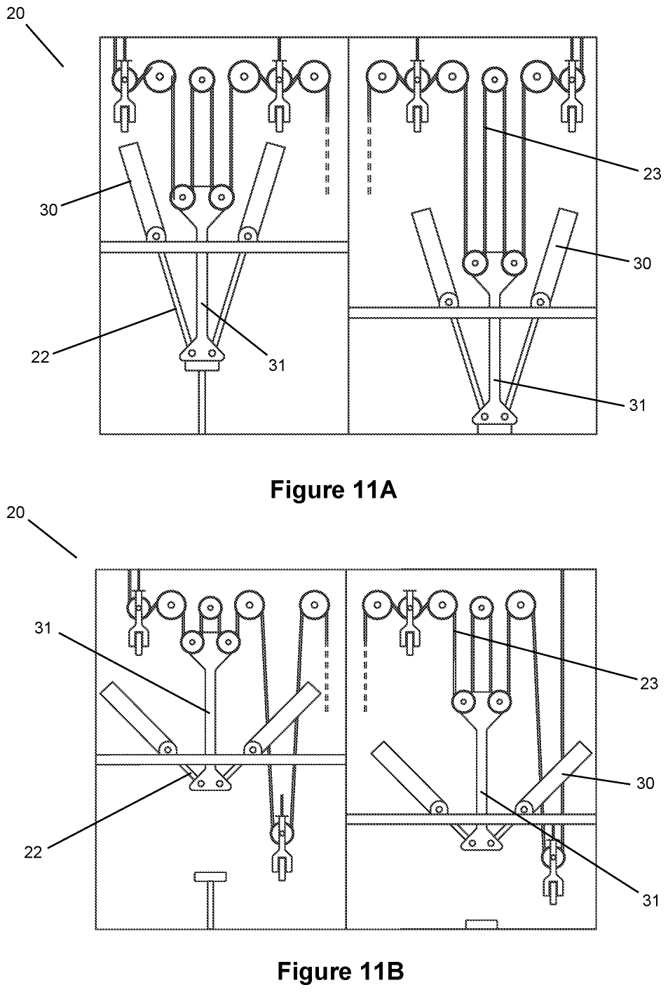

The adjustable resistance mechanism (2) utilised in the apparatus (20) is best shown in FIGS. 11A and 11B. Cable pulling movement of the user operation means results in linear movement of sliders (31) (via the pulley system) in a vertical direction toward the top of the frame (19). Each slider (31) is connected to a pair of pneumatic cylinders (30) such that movement of the slider (31) due to cable pulling movement compresses the cylinders (30) to provide the resistance. The arrangement of the sliders (31) and cylinders (30) is such that, in one mode, a substantially constant resistance may be provided. The cylinders (30) are pivotally mounted to the frame and sliders (31) such that as the sliders (31) move upward, the angle between the movement direction of the sliders and the expansion direction of the respective connected cylinders increases. Therefore, with movement of the sliders in the upward direction, the component of force provided by the cylinders (30) against the movement direction decreases. This decrease of force is compensated for by the increase in pressure that occurs with compression of the cylinders so that a substantially constant resistance is provided. As shown, the cylinders (30) of each pair that accompany a particular slider (31) laterally oppose one another such that the component of force provided by each pair of cylinders in the lateral/horizontal direction is counter balanced.

In typical use, when the user operation means (e.g. handles or sliding bed) are in the retracted position, the cylinders are in an expanded state and the angle between the expansion direction of the cylinders and the direction of movement of the respective slider is small (e.g. in FIG. 11A). Therefore a large component of the cylinder expansion force is against the movement direction of the slider. With the pulling of the user operation means, the sliders (31) lift, and the angle between the expansion direction of the cylinders (30) and the respective slider (31) movement direction increases (e.g. see FIG. 11B). Thus the component of force against the movement direction of the slider decreases. The decrease in force against the movement direction of the sliders is compensated for by the increase in pressure that occurs with compression of the gas in the cylinder. As the cylinders have pre-set amount of gas therein, the resistance to compression increases as the gas in compressed. It will be appreciated that the level of resistance may be adjusted by adjusting the amount of gas in the cylinders. This is typically achieved via pneumatic valves that are controllable by the control system.

Typically, one or more, displacement measurement devices are included to provide feedback to the control system of exercise “stroke” e.g. how far the handles or sled/bed/seat/carriage have been moved/pulled out, and at what speed. Based on this information the control system may be configured to provide feedback to the user, e.g. a live rep count via one or more of the displays, or instructions to increase or slow the speed of the stroke or parts thereof. The control system may also be configured to automatically record/store the stroke information, for example, in a user profile on a remote/cloud based database. In this way a user is able to easily log/track their progression with a particular exercise. It will be appreciated that the control system may also receive exercise stroke information from a wearable sensor or by processing of camera image data.

Typically, the displacement measurement devices are linear measurement devices (e.g. a LVDT—Linear Variable Differential Transformer) mounted to the pneumatic cylinders measuring expansion/compression thereof. However, it will be appreciated that displacement measurement device may be configured to measure movement of other members, such as, for example, the sliders (31) or the user operation means (e.g. bed/handles). Displacement measurement devices may also be configured to monitor/measure cable movement.

Whilst the system is generally configured to provide a substantially constant resistance, to mimic conventional weights, the mode of operation may be adjusted such that the amount of resistance may be actively/dynamically controlled by the control system. By actively controlling the pneumatic valves and/or using feedback from the displacement measurement devices, the control system may be configured to provide customized resistance profiles for the user by actively controlling pressure in the pneumatic cylinders. For example, the resistance may be set to increase during a particular part of the exercise stroke. For example, when performing a bicep curl, the resistance may be set to increase during the last 20% of the flexion stroke.

It will be appreciated that in some forms, the control system may also be configured to receive input in relation to a user's characteristics or identity (e.g. age, gender, name, id), and, based on that input, optimise the exercise apparatus/exercise bay for the user. For example, by automatically adjusting exercise apparatus/equipment to preferred settings, with preferred resistance etc. This setting information may, for example, be retrieved from a user profile stored locally or on a remote/cloud based database once a user “logs in”.

In some forms, control system may be configured to process image data of a user captured from the at least one camera to determine an optimised configuration of the exercise apparatus/exercise bay for the user, and to subsequently configure the exercise apparatus/exercise bay accordingly.

The use of a pneumatically powered resistance mechanism provides advantages in that operation is a quieter and the apparatus as a whole is a lighter than when using conventional weights. It will be appreciated that when used with the exercise bay (1), the frame (19) of the exercise apparatus (20) is typically embedded in wall of the exercise bay (1) such that the pulley system and resistance mechanism are hidden from the view of the user.

FIG. 15 shows typical integration of control system components with the modular exercise bay (1), exercise apparatus (20), and external/remote devices. The control system includes a processing unit (100) (e.g. may include Central Processing Unit, microcomputer, microcontroller) connected with a communication module (102). The communication module allows connectivity to communication networks (e.g. Local Area Networks, Wide Area Networks, the Internet, etc.) as well as direct connectivity to external devices, such as, for example, mobile communication devices (e.g. smartphones, tablets) (103), or wearable sensors (104) etc. Typically, the communication module (102) includes Wi-Fi and Bluetooth modules.

The videos cameras (101) and one or more displays (5) of the exercise bay (1) are operatively connected to the processing unit (100). A user inputs information/instructions/commands to the processing unit (100) via a user interface (106). The processing unit (100) is typically configured to control the output of the visual displays (105) based on user input, such as, for example, in relation to a desired an exercise to be performed.

It will be appreciated that the user interface may take a variety of forms. The user interface (106) is typically a touch screen graphic user interface. The user interface (106) may also be configured to receive commands/input via voice i.e. it may include a microphone and sound capture functionality. It will be appreciated that in other forms, user/input commands to the control system by received other means, such as, from a mobile communication device (e.g. smart phone).

The processing unit is also connected to an exercise apparatus controller (107) (e.g. a microcontroller or the like)) which is configured to control aspects of the exercise apparatus (20) in the exercise bay (1). As shown, the exercise apparatus controller (106) is configured to control multiple aspects of the exercise apparatus (20). For example, the controller is configured to control pneumatic valves (108, 109), which control air supply to the pneumatic cylinders, and therefore, the resistance provided. Control signals may also be sent to linear drive motors (112, 113) which operate to adjust heights of the wide and narrow grip handles (24a, 24b).

Displacement measurement devices (110, 111) mounted to the pneumatic cylinders, provide feedback to the controller (107) in relation to exercise “stroke”. As shown signals/information are also typically communicated between the sliding bed apparatus (25) and the apparatus controller (107). Communication with connector (40) allows control of engagement/disengagement of the bed/sled (26) with the pneumatic resistance mechanism. Motor (114) operates to move the sliding bed apparatus between the stowed and deployed configuration.

The control system integration as shown FIG. 15 is one example of many possible configurations and it will be appreciated that the control system may be configured to operate/control a variety of the elements of the exercise bay and apparatus not shown in the figures. It will also be appreciated that the various aspects of the exercise bays as described herein may be automatically adjusted by the control system based information received from sensors/cameras and/or may be based on information/instructions input by a user (e.g. via user interface or via voice).

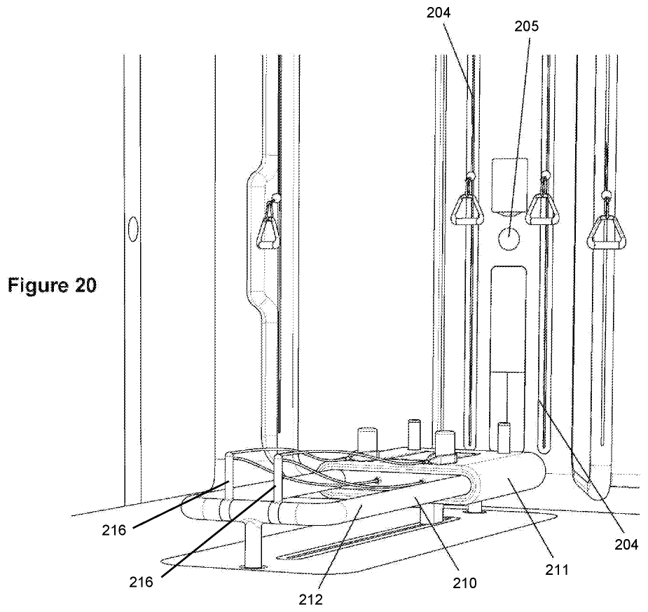

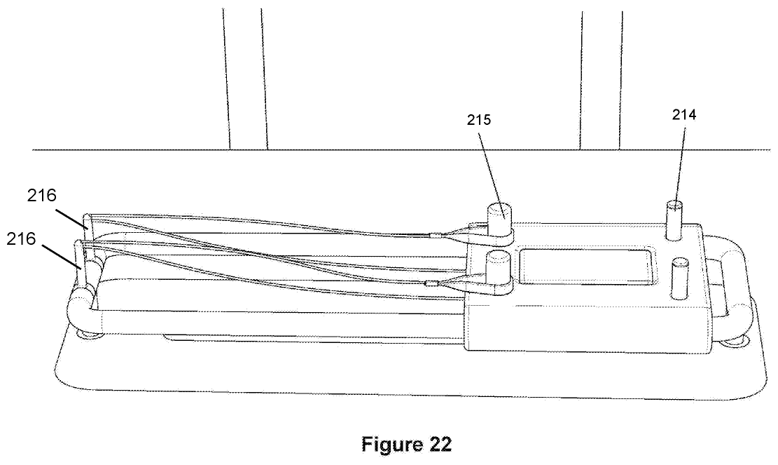

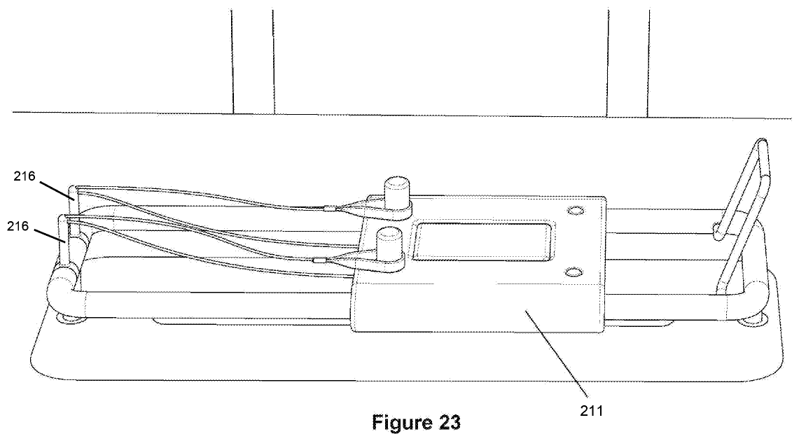

A further example of an exercise bay according to the invention is shown in FIGS. 16 to 27. In this example, exercise bay (200) is substantially cube shaped, and has two display screen arms (201a, 201b) that are hingedly mounted to an internal side wall thereof (202). The display screen arms (201a, 201b) operate as adjustable arms of a cable pull type exercise apparatus (e.g. functional trainer) that is otherwise embedded into the structure of the bay (200). Only the display screens arms (201a, 201b) and handles (203) are exposed to a user inside the bay (200). The resistance mechanism and cable pulley system are substantially hidden/embedded in the bay structure.

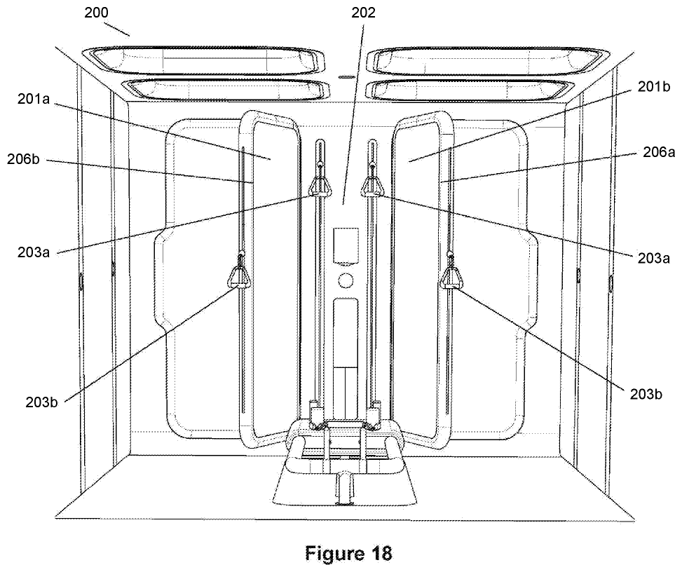

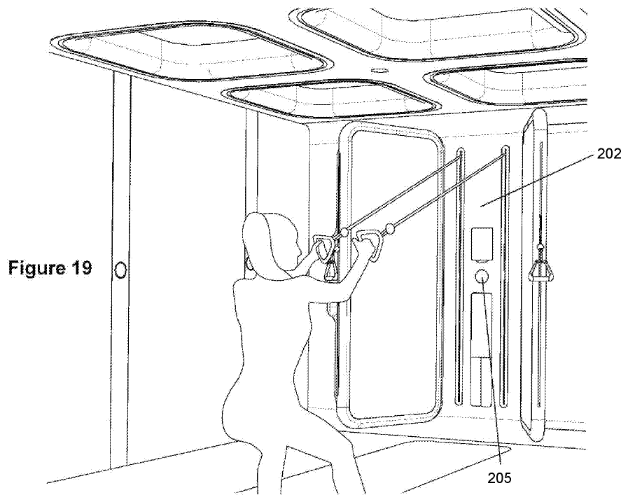

As shown in FIGS. 18 and 19, the display screen arms (201a, 101b), are dual functioning, acting as adjustable arms for the wide grip/outer handles (103b), and also providing display surfaces for a user to view content whilst performing exercise. As previously described, the display screens arms (201a, 201b) may, for example, display instructional videos, live video feeds of the user, and/or other information e.g. heart rate, rep count etc. In the example shown, the arms (201a, 201b) are substantially rectangular with the display surfaces thereof extend substantially over the entire inward facing surfaces thereof. The rectangular display screen arms (201a, 201b) are mounted to the wall (202) along a first proximal edge thereof while the wide grip/outer handles (203b) are located at the opposite distal edges thereof (206a, 206b).

A camera (205) is mounted to the wall (202) between the display screens to, for example, capture live video of a user. As previously described, it will be appreciated that a multiple cameras may be located at different position in the bay (200) to capture different angles/views of user exercising therein.

The cable pull type apparatus in this example includes four handles (203), two narrow grip handles (203a), and two wide grips handles (203b). The narrow grip handles (203a) are located between the hinged display screens arms (201a, 201b), in parallel vertical tracks (204) in the bay wall (202). The wide grip/outer handles (203b) are located at the distal edges (206a, 206b) of the display screen arms (201a, 201b). The height of the handles (203b) may be adjusted by sliding same up and down along the distal edges (206a, 206b) of the display screen arms (201a, 201b).

The exercise bay (200) also includes a sliding bed apparatus (210), that has a sliding bed (211) slidingly mounted to a base frame (212). Typically, the sliding bed apparatus (210) would utilise the adjustable resistance mechanism (not shown) of the cable pull type exercise apparatus. Although, it will be appreciated that in some forms, it may be a standalone apparatus. Typically, cables for the bed are routed through the floor to connect to/share the pulley system/resistance mechanism of the cable pull type exercise apparatus. For example, the exercise bay (200) may include as exercise apparatus with functionality similar to the exercise apparatus (20).

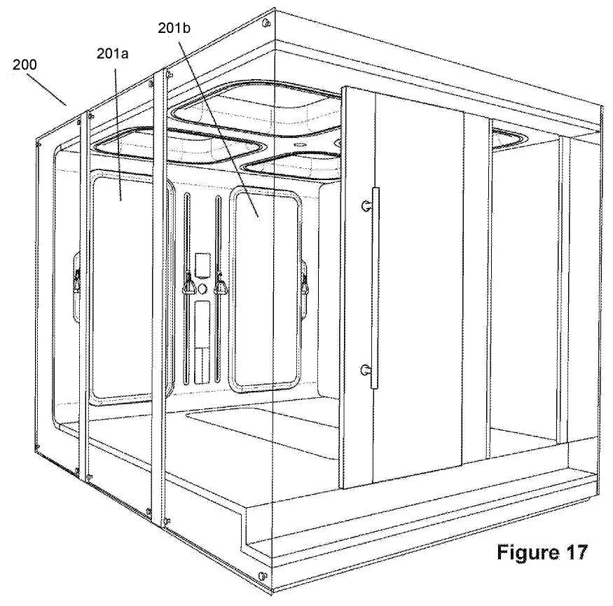

In the example as shown, the sliding bed apparatus has a stowed position in the floor (i.e. beneath a false floor) that allows for the full floor area of the bay to be used for floor based exercises, like yoga, push ups, standing squats and the like, or for cable pull type exercises to be performed (see for example FIGS. 17 and 19).

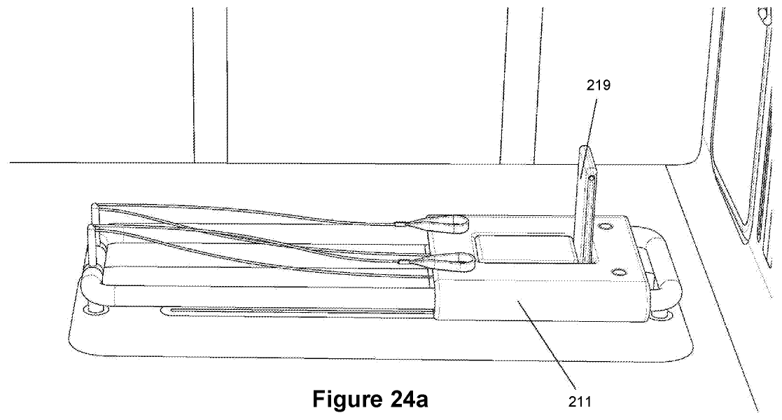

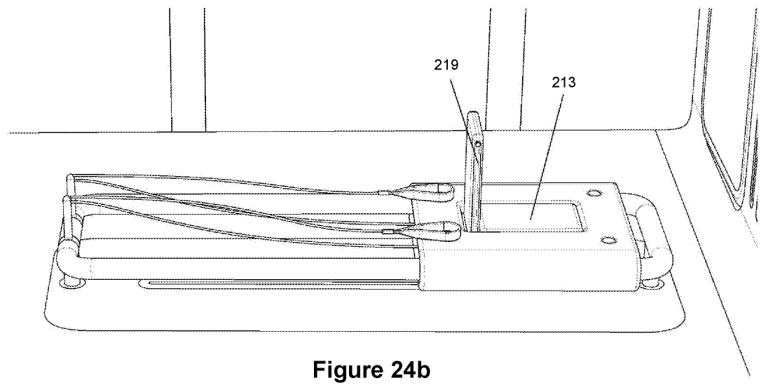

The bed (211), of the sliding bed apparatus (210), is also configurable to allow for different exercises to be performed e.g. Pilates type, rowing, leg press type etc. For example, the bed (211) has back and chest support built in. A double pivoting pad (219) allows for the same pad to be used in different positions (i.e. as a back rest or chest support), whilst a filler portion (213) rises up to create a flat bed surface when the pad is raised. FIGS. 24a and 24b shows how the pad (219) may pivot between positions.

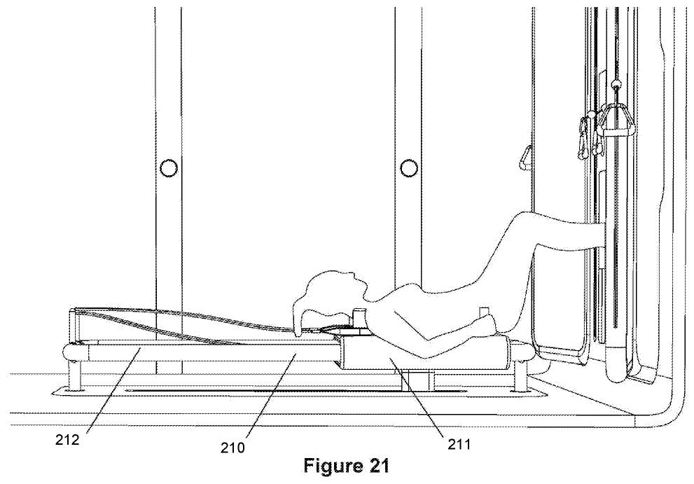

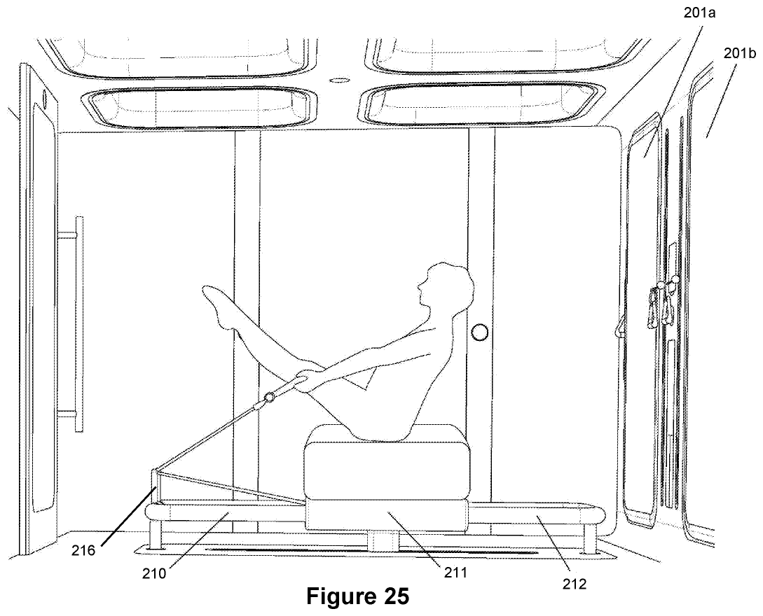

The sliding bed also includes stowable handles (214) and shoulder rests (215) that may be utilised during certain exercises (see for example FIG. 21), and may be stowed to provide a flat bed surface for other exercises (see for example FIG. 25). The shoulder rests (215) may also be used a foot pads during Pilates type exercises. A fold up/fold down handle (216) is also included (which may also be used as a foot rest). The handles (214), shoulder rests (215) etc. would typically automatically deploy/stow on user selection of a particular exercise to be performed. Risers (216), through which ropes are threaded for Pilates type exercises, are also typically adjustable in height (and may also automatically adjust based on user preferences/profile).

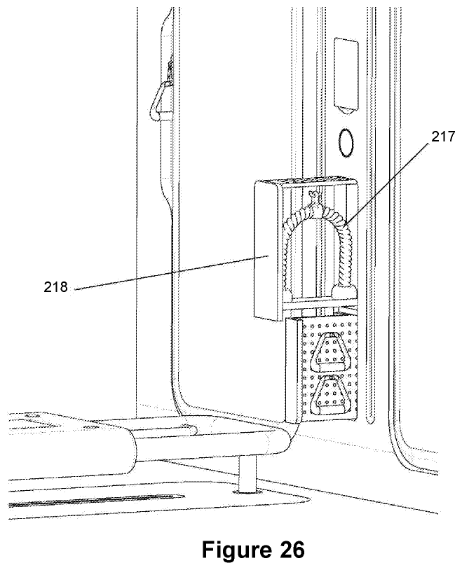

It will be appreciated that the exercise bay (200) would typically also include a control system with computing/processing/control functionality as previously described. Other sensors may also be included. For example sensors may be configured to detect whether exercise accessories are stored appropriately before exercise equipment is permitted to function. FIG. 26 shows how, in one example, accessories (217) may be stored in slide out compartments (218).

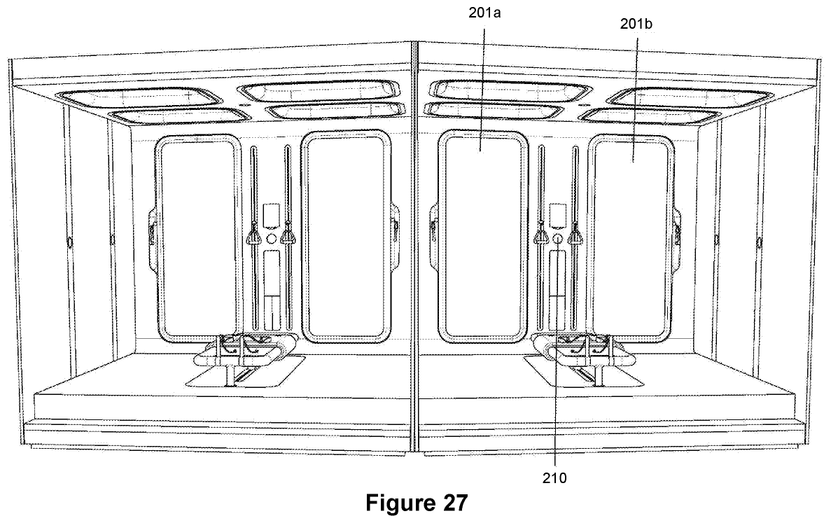

As shown in FIG. 27, multiple bays may form modules of a larger network of bays. The enclosure walls in this example are formed of translucent glass, and certain panels may be removed to allow bays to link together.

It will be appreciated that the described exercise bays and associated exercise apparatuses address common issues that deter people from performing exercise. In particular the self assessment capability allows safe and quality exercise to be performed without the expense of hiring a personal trainer. Furthermore, the privacy provided by the exercise bay avoids fear or embarrassment that may be brought on by exercising in front of others.

For example, one particular exercise that may be facilitated by the exercise bay and the associated exercise apparatus is the deadlift. It is widely believed that the most valuable exercise that can be used to change an individual's physical shape is the deadlift. However, there are inherent dangers in this very complex lift which makes it difficult for beginners. By clearly showing correct form for the deadlift via video feed, and having an exercise apparatus that effectively supports the user during movement, the modular exercise bay allows the deadlift to be performed in a safe manner without a trainer present. This allows beginners of all fitness levels to perform this movement safely.

It will also be appreciated that herein described exercise bay and exercise apparatus provide more robust user data than more conventional data recording devices like wearable sensors etc. which can be inaccurate when recording exercise information. The integration of control system components, such as displacement measurement devices, into the exercise apparatus itself allows for accurate exercise ‘stroke’ information to be recorded.

It will also be appreciated that the network/internet connectivity and cloud based storage of user profile information allows for a range novel functionality. For example, health professionals may prepare and upload rehabilitation programs to a cloud based server that a user can then select for display in the exercise bay. Furthermore, the exercise bay provides that users are able to stay up date with the latest developments in training technique, as the library of exercise videos accessible from the bay may be regularly updated by leading professionals.

In some forms, augmented reality devices may be incorporated into the exercise bay, such as, for example augmented reality eyewear that projects images of objects for a user to negotiate. For example, a user may exercise by jumping imaginary hurdles that are perceived to be moving towards them. In other forms, exercise bays may be configured to allow users to compete with one another, with the video feeds of different competitors being transferred between bays.

The modular exercise bay can also be used as a data collection device, to collect exercise information as well as user characteristic or identity information and, based on collected information, propose appropriate programs for particular users according to their characteristics (e.g. age, weight) or identity (e.g. by reviewing past training sessions). It will be appreciated that the collected information may be stored on a remote/cloud based server/database accessible via the exercise bay. It will also be appreciated the data from multiple bays may be collectively collated.

It will also be appreciated that as the exercise apparatuses as described herein allow multiple forms of exercise to be performed (e.g. Pilates, resistance training, cable pull type), and therefore it may be the only piece of equipment required for a gym. For example, separate Pilates machines, functional trainers, resistance machines would not be required as they may all be incorporated into the exercise apparatus as described herein. A gym facility owner is therefore able to provide a variety of services/classes, with limited floor space.

Basic versions of the exercise bay may also be provided without cameras that provide live video back functionality. In such examples, the exercise bays would typically include at least one exercise apparatus, and at least one display within the enclosure thereof

It will also be appreciated that a range of different sensor types may be used to detect/collect user information and range of feedback devices may be implemented to provide feedback to the user. Therefore, according to one aspect, broad embodiments of the invention provide exercise bays having an enclosure defining an exercise area, at least one sensor directed toward the exercise area configured to collect information about a user exercising in the exercise area, and a feedback device configured to provide feedback to a user about their exercising (e.g. form, heart rate, performance) based on information received from the at least one sensor.

For example, the feedback device may be configured to provide audio and/or visual feedback to a user about their exercise form. Typically, the feedback device is configured alert the user when they deviate from proper exercise form. The feedback device may be, for example, a display screen, augmented reality or virtual reality headset, and/or a speaker. The at least one sensor may include, for example, an optical sensor, image sensor, electrical sensor, audio sensor, camera and/or heart rate monitor. The exercise bay may also automatically adjust in accordance with information received form the at least one sensor about the user.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An exercise bay including:
an enclosure defining an exercise area;
plurality of cameras for capturing video of a user exercising in the exercise area;
a control system configured to automatically selectively operate and/or adjust the physical orientation and/or position of the plurality of cameras in accordance with an exercise to be performed by the user such that video captured by the cameras is optimized for the exercise to be performed; and
at least one display within the enclosure configured to display captured video of the user in real time.

22. (canceled)

23. (canceled)

24. (canceled)

25. (canceled)

26. (canceled)

27. (canceled)

28. (canceled)

29. (canceled)

30. An exercise bay as claimed in claim 21, wherein the control system is configured to automatically selectively operate, and/or adjust the physical orientation and/or position of the at least one display in accordance with the exercise to be performed such that visibility of the at least one display is optimize for viewing by the user when performing the exercise.

31. An exercise bay as claimed in claim 21, further including at least one exercise apparatus therein.

32. An exercise bay as claimed in claim 31, wherein the control system is configured to automatically configure the at least one exercise apparatus in accordance with the exercise to be performed.

33. An exercise bay as claimed in claim 31, wherein the control system is configured to automatically optimise the at least one exercise apparatus for the user based on user profile information.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. An exercise bay as claimed in claim 33, wherein a user profile information is generated from user image data captured from one or more of the plurality of cameras.

47. An exercise bay as claimed in claim 33, wherein user profile information includes a user characteristic information, user identity information, user demographic information, user health information and/or user fitness information.

48. An exercise bay as claimed in claim 31, wherein the at least one exercise apparatus is multimodal such that it is configurable to allow exercise to be performed from standing, seated and laying positions.

49. An exercise bay as claimed in claim 48, wherein the at least one exercise apparatus includes:
at least one user operation means; and
an adjustable resistance mechanism connected to the at least one user operation means via a cable pulley system,
wherein the adjustable resistance mechanism is configured to provide resistance against cable pulling movement of the at least one user operation means, and the at least one user operation means is movable between retracted and extended positions to perform exercise.

50. A exercise bay as claimed in claim 49, wherein the at least one user operation means includes handle members and a sliding bed apparatus, the handle members and sliding bed apparatus usable alternatively or in combination to perform different exercises.

51. An exercise bay as claimed in claim 21, wherein the enclosure has opaque or translucent walls, such that a user exercising within the enclosure is not visible or identifiable from outside the enclosure.

52. An exercise bay as claimed in claim 21, wherein the control system is configured to operate the at least one display to display content relevant to the exercise to be performed simultaneous with the real time video of the user performing the exercise.

53. An exercise bay as claimed in claim 21, wherein content relevant to the exercise to be performed is received from a remote location, via a communication network.

54. An exercise bay as claimed in claim 21, wherein the control system is configured to operate the display to display user profile information simultaneous with the real time video of the user performing the exercise.

55. An exercise bay as claimed in claim 21, further including an input device configured to receive input indicative of the exercised to be performed by the user.

56. An exercise bay as claimed in claim 21, wherein the plurality of cameras are configured to capture video from at least two angles.
